(19) United States
(12) Patent Application Publication
(10) Pub. No.: US 2007/0073546 A1
(43) Pub. Date: Mar. 29, 2007

(54) Secure Real Estate Info Dissemination System

(76) Inventor: Engelbert Wolfgang Kehren, North Miami Beach, FL (US)

Correspondence Address: Engelbert Wolfgang Kehren, 3302 NE 171st Street, North Miami Beach, FL, 33160, US

(21) Appl. No.: 11/162,927

(22) Filed: Sep. 28, 2005

(51) Int. Cl. G06Q 99/00

(52) U.S. Cl. 705/1

(57) ABSTRACT

A system for general data dissemination and, more particularly, to disseminating pictures and sounds relating to real estate properties, using a secure radio frequency data link communicating with a PC, laptop, PDA, or cell phone. A sealed, high-security data dissemination device, using standard-availability data-retrieval systems and standard data protocol, enhancing a real estate professional's ability to communicate features of a home without the prospective clients having to stop and physically view the property.

### FIELD OF INVENTION

The present invention relates to general data dissemination and, more particularly, to disseminating pictures and sounds relating to real estate properties, using a secure radio frequency data link communicating with a PC, laptop, PDA, or cell phone.

### BACKGROUND—DISCUSSION OF PRIOR ART

As stated by Hartz, Jr. et al. in U.S. Pat. No. 6,636,803,

“Buying a home is one of the most important experiences in a person's life, and one of the most expensive. The home a person buys ultimately depends on the quantity and quality of information he or she is able to obtain about the market place prior to purchase. Locating this information for the buyer is the job of the real estate agent.

The techniques real estate agents currently use are antiquated and largely ineffective. A typical scenario involves assigning a buyer to an agent who has at least a working knowledge of a particular area of the market. During an initial consultation, the buyer gives the agent an idea of property he or she would like to buy or rent and a general idea of where that property should be located. Based on this information, the agent searches the Multiple Listing Service (MLS) database to locate properties that are currently available. A second meeting is then set up with the buyer for the purpose of visiting those properties.

During the second meeting, the agent must figure out exactly where the properties are located. A route must then be plotted for visiting those properties. This is usually done using paper maps and print-outs of MLS listings, which the agent often carries within him in the car. The use of paper maps and MLS listings has proven to be time-consuming, cumbersome, and generally inefficient.

Another drawback of current techniques relates to the need to physically visit properties with the market. Once the agent knows the general area of interest to the buyer, he usually escorts the buyer to each of the properties. Many times, however, the buyer does not even enter the properties because he can tell from just their outward appearance that they are unsuitable. The need to physically visit each and every property in a market to determine whether they are suitable wastes the buyer's and agent's time and, further, adds to the inefficiency of the home-buying experience.

Undoubtedly, there is a need for the real-estate industry to embrace new technologies in meeting buyers' needs. The industry has admittedly done a poor job doing so. Today, nearly two-thirds of all real estate brokers do not have a web presence, and nearly one third do not even use e-mail in their jobs. While this trend is slowly changing, the underlying process remains substantially the same. In the vast majority of cases, real-estate agents still rely on paper resources to develop property tours for buyers and are still required to chauffeur customers to physical property sites.

In view of the foregoing considerations, it is clear that there is a need for an improved system and method for developing property information that can be used by real-estate agents in assisting their customer needs.”

Today, audio systems are offered which allow potential buyers to listen to a presentation on a given property, by receiving such information on a regular automobile radio.

Other systems require pre-recorded computer readable medium to be supplied for a given geographic area. The generation of which is costly and rapid market sales make them obsolete as soon as they are generated.

Internet based systems are available, but are not available to people driving through a desired neighborhood.

### OBJECTS AND ADVANTAGES

It is therefore the object of the present invention to provide a secure, flexible, low-cost system, using state-of-the-art, readily available technology, to respond to a request from a computer, laptop, PDA, or advanced cell phone, with detailed audio and visual presentation, using a standard high-speed wireless data link presently available on most laptops and PDA's. The device is a plastic-encapsulated device with only a low-voltage power connector and, for the longer-range version, an external antenna. The single-house-only system has an integrated antenna.

This system enables the real estate broker to allow the buyer-client to more effectively explore real estate opportunities. The broker does not have to spend time and fuel to drive a client around to show areas which may or may not be of interest. The client can explore independently and download all pertinent information which would help to answer the question as to whether the property in question is a candidate for closer scrutiny. In addition, there are neighborhoods where “stop-and-go looking” is almost impossible due to traffic patterns and no-passing zones—often on waterfront streets.

In addition, the client-user can discover properties of which the broker was possibly not aware or which did not match the desires the potential buyer had communicated.

Real estate professionals seeking properties for their clients will be able to gather data more effectively for their clients by driving around in specific areas and downloading information, far exceeding that which is presently easily accessible in listings.

The net result of the system is a more-effective way for the real estate professional to assist a client, allowing the client to research more opportunities in a shorter time, by gathering data while driving without stopping; then, when off the road, the client can review in more detail only those prospects that did make a positive impression.

To make this system a success, the following factors are absolutely mandatory: data security, low cost, no maintenance, low power usage, flexibility, and user-friendliness, in that the users would typically have available the equipment needed to access the system. A broker might have such equipment on hand (such as a laptop) to rent or loan a client.

This invention covers all the requirements listed, and it makes for a cost-effective solution to improving the search for a home.

### BRIEF DESCRIPTION OF THE DRAWINGS

FIG. 1 is a block diagram of the system.

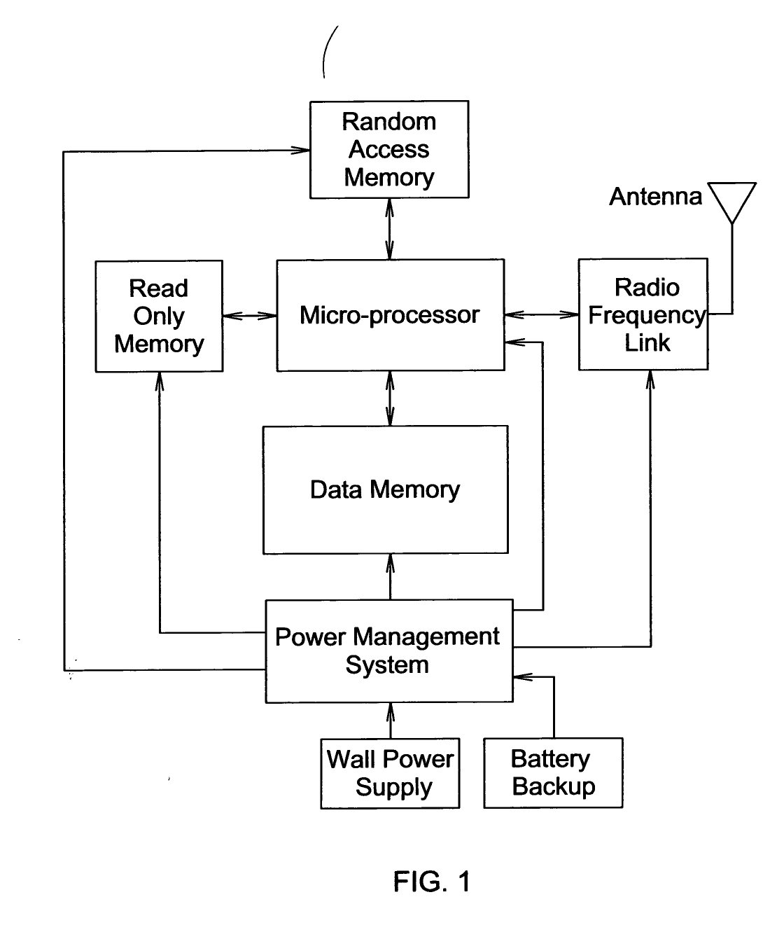

FIG. 2 shows the mechanical outline of the house system.

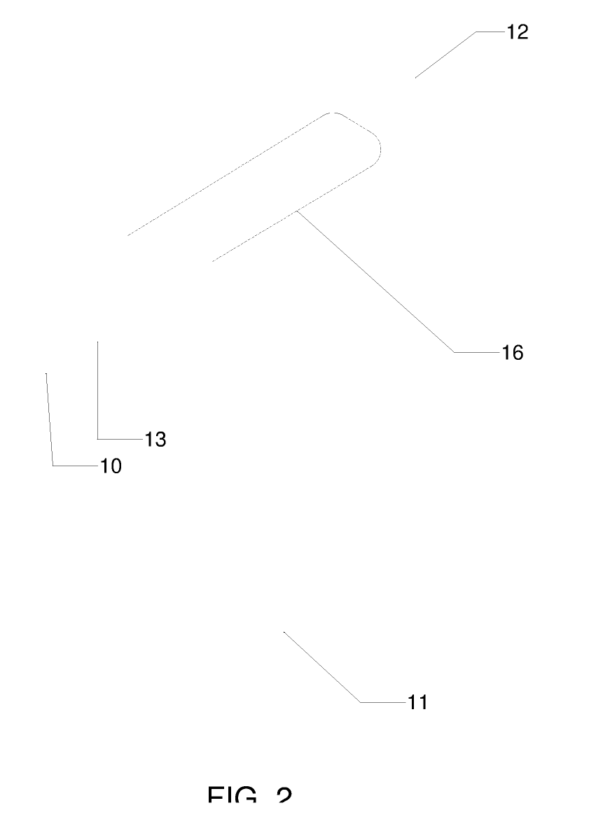

FIG. 3 shows the mechanical outline of the longer-range system to cover multiple blocks with general information.

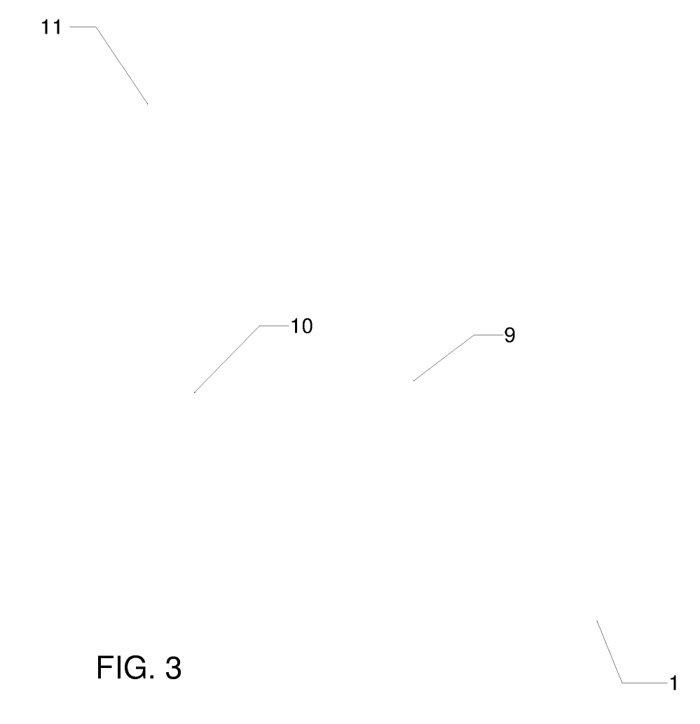

FIG. 4 shows an X-ray view of the inside of the fully-encapsulated system.

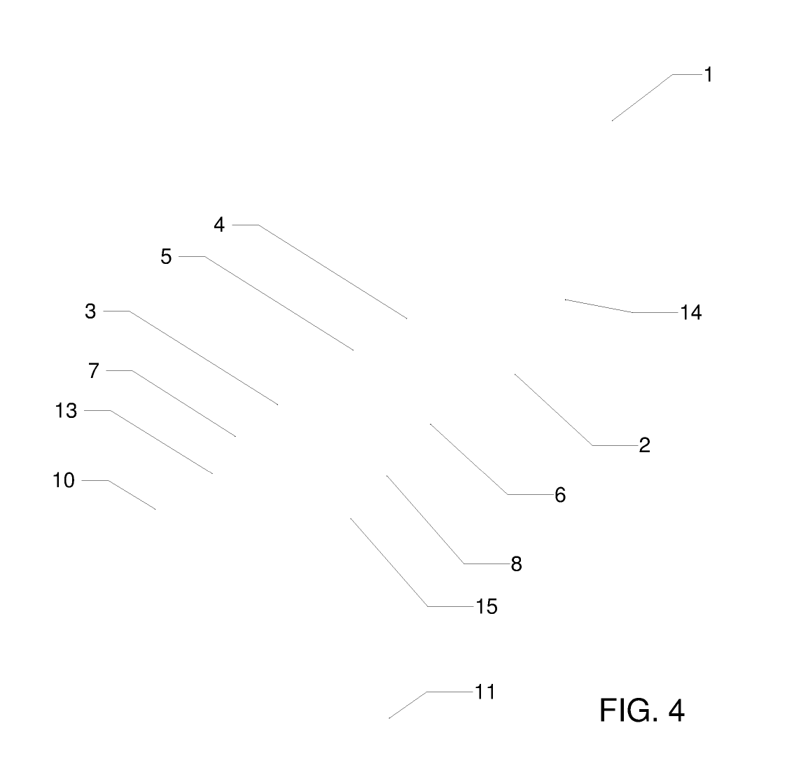

### REFERENCE NUMERALS IN THE DRAWINGS

1. Antenna
2. Radio Frequency link
3. Random Access Memory
4. Read Only Memory
5. Data Memory (Flash)
6. Microprocessor
7. Power Management System
8. Battery Backup (Option)
9. Encapsulated Case
10. Power Connection, male
11. Power Module
12. Encapsulated Case, with Integral Antenna
13. Power Connection, female
14. Radio Frequency Antenna Connector
15. Circuit card
16. Integral Antenna

### DESCRIPTION OF THE PREFERRED EMBODIMENTS

This invention combines readily available components and products to form a system that effectively disseminates important real estate information. It is packaged in such a way that it will be next to impossible for a hacker to break into the system, adopt a system, or duplicate a system.

The basic reusable module is controlled by a central microprocessor, which is responsible for controlling RAM, ROM, data memory, and the RF link. This processor also has embedded encryption, making it very difficult for a hacker to gain access to the algorithm. By power-cycling, consisting of positive and negative pulses, the unit can be reset into a primitive state, making it possible to program it using the RF link. There is no other access to the internal workings of the unit. Data can be loaded to the unit using a computer with the appropriate RF link capability, such as today's 802.11g. Data is encrypted in such a way that the microprocessor will only store data in its memory when proper checks are passed. Data memory is presently envisioned at 64 Mbyte, but it can be expanded in the future as the market demands.

The data memory information can be generated by individuals using standard presentation systems; however, this data has to be submitted via Internet to a central processing facility, where it is converted and checked for viruses. The data is subsequently downloaded to the requesting real estate brokerage, which, possessing such a module, is able to download the information to be disseminated. Updates to controlling software can also be sent via Internet from a central control station, for instance, to change the encryption. In case of malfunction, the unit can be submitted for reset to a regional office, which resets it into its basic state using power cycling and subsequently reloads its controllability software.

In order to ensure secure dialogue, the potential user (buyer-client) is furnished a CD-ROM, which loads into the user's device (PC, laptop, PDA or cell phone) the necessary information which allows a secure transfer of data. This CD-ROM can also have additional data, such as maps of the area, schools, shopping, and tax information for the region, allowing the buyer to make educated decisions. Any access to the module is recorded by the module, allowing the listing broker to review interest and comments by the visitors to the site.

What is claimed is:

1. A method of displaying sales information to prospective buyers about real-estate property on a mobile computing device, comprising a wireless transmitting device and a wireless receiving device capable of displaying said information.

2. The method of claim 1, wherein said wireless transmitting device includes data storage means, a microprocessor, and an RF link.

3. The method of claim 1, wherein said wireless transmitting device includes data storage means, a microprocessor, and an RF link, any one, or all of which, are a part of a personal computing device.

4. The method of claim 1, wherein said wireless transmitting device is a reusable module which may be re-loaded with said sales information.

5. The method of claim 3, wherein said reusable wireless transmitting device is re-loaded with said sales information via said RF link.

6. The method of claim 1, wherein said wireless receiving device is a wireless enabled computer, a Personal Data Assistant, or wireless phone.

7. The method of claim 1, wherein said wireless transmitting device includes a means for securing the data stored there within.

8. The method of claim 6, wherein said securing means includes data encryption.

9. The method of claim 1, wherein said wireless transmitting device resides within the property being offered for sale and said RF link is sufficiently low power such that its output is only received locally.

10. A system of displaying sales information to prospective buyers about real-estate property including software which is utilized by a portable computing device to communicate with said wireless transmitting device for the purpose of retrieving said encrypted data.

11. The system of claim 9, wherein said software allows for said data to be up-loaded to said wireless transmitting device.

12. The system of claim 9, wherein software is utilized for the generation of said real-estate information to be stored within said data storage means within said wireless transmitting device.

13. The method of claim 2, wherein said wireless transmitting device can be reset into a primitive state, making it possible to program it using the said RF link by power-cycling, consisting of positive and negative pulses, thus there is no other access to the internal workings of said transmitting device.

14. The system of claim 9, wherein said software is contained on a computer-readable medium to be implemented in a processing unit of a mobile computing device, said computer-readable medium including an authentication section, which allows access to the said sales information data only to authorized users.
